(19) United States
(12) Patent Application Publication
(10) Pub. No.: US 2022/0100210 A1
(43) Pub. Date: Mar. 31, 2022

(54) CONTROL METHOD FOR UNMANNED AIRCRAFT, SERVER, AND UNMANNED AIRCRAFT

(71) Applicant: TOYOTA JIDOSHA KABUSHIKI KAISHA, Toyota-shi (JP)

(72) Inventors: Ai MIYATA, Okazaki-shi (JP); Yurika TANAKA, Yokosuka-shi (JP); Hideo HASEGAWA, Nagoya-shi (JP); Hiroyuki SUZUKI, Miyoshi-shi (JP); Katsuhiro OHARA, Nagoya-shi (JP); Tomoya MAKINO, Kariya-shi (JP)

(73) Assignee: TOYOTA JIDOSHA KABUSHIKI KAISHA, Toyota-shi (JP)

(21) Appl. No.: 17/487,620

(22) Filed: Sep. 28, 2021

(30) Foreign Application Priority Data
Sep. 30, 2020 (JP) 2020-166278

(51) Int. Cl. G05D 1/10; G01C 21/20; B64C 39/02; B64D 47/08; G08G 5/00

(52) U.S. Cl. CPC G05D 1/106; G01C 21/20; B64C 39/024; B64C 2201/14; G08G 5/0034; B64C 2201/127; B64D 47/08

(57) ABSTRACT

A processor included in a first controller and/or a second controller generates a route for flying preferentially over a road and a waterway, based on a current position of an unmanned aircraft, a destination, and map information. Further, the processor controls flight of the unmanned aircraft based on the generated route.

### CROSS-REFERENCE TO RELATED APPLICATION

This application claims priority to Japanese Patent Application No. 2020-166278 (filed on Sep. 30, 2020), the entire contents of which are incorporated herein by reference.

### TECHNICAL FIELD

The present disclosure relates to a control method for an unmanned aircraft, a server, and an unmanned aircraft.

### BACKGROUND

An apparatus for setting a flight route for an unmanned aircraft, such as a drone, and providing route guidance to a destination has been proposed. For example, according to Patent Literature (PTL) 1, it is described that an apparatus that sets a flight route for a drone and transmits, to the drone, flight instruction data as a sequence of coordinate points including latitudes, longitudes, and altitudes in accordance with the topography or the like between a departure point and a destination of the drone.

### CITATION LIST

### Patent Literature

PTL 1: JP 2018-165930 A

### SUMMARY

When a route for an unmanned aircraft is set based solely on topography, structures on the ground, or the like, the unmanned aircraft can fly an inappropriate route. The inappropriate route includes, for example, the airspace above housing, schools, parks where people gather, busy quarters, and the like. Such a route may cause a sense of fear and restriction among people in the vicinity of the route along which an unmanned aircraft flies, or may cause a person and an object annoyance, such as being collided with, when the unmanned aircraft lands on the route due to a fault or the like.

It would be helpful to cause an unmanned aircraft to fly along a safe route to a destination.

A control method for an unmanned aircraft in accordance with an embodiment of the present disclosure includes generating, by a processor, a route for flying preferentially over a road and a waterway, based on a current position of the unmanned aircraft, a destination, and map information. The control method further includes controlling, by the processor, flight of the unmanned aircraft based on the generated route.

A server according to an embodiment of the present disclosure includes a first communication interface configured to transmit and receive information to and from a plurality of unmanned aircraft, a first processor, and a map database configured to store map information. The first processor is configured to generate a route for flying preferentially over a road and a waterway, based on a current position of an unmanned aircraft in the plurality of unmanned aircraft, a destination, and the map information, and transmit route information related to the generated route to the unmanned aircraft via the first communication interface.

An unmanned aircraft according to an embodiment of the present disclosure includes a second communication interface, a second processor, a camera, and a flight unit. The second communication interface is configured to receive route information and map information, the route information being related to a route for flying to a destination preferentially over a road and a waterway. The second processor is configured to control the flight unit based on the route information and the map information, and generate a route to the destination again based on traffic volume of pedestrians and vehicles passing through the route that is detected from an image captured by the camera during flight.

According to the present disclosure, a control method for an unmanned aircraft that is capable of causing the unmanned aircraft to fly along a safe route to a destination, a server, and an unmanned aircraft compliant with the above control method can be provided.

### BRIEF DESCRIPTION OF THE DRAWINGS

In the accompanying drawings:

FIG. 1 illustrates a schematic configuration of an unmanned aircraft control system according to an embodiment of the present disclosure;

FIG. 2 is a block diagram illustrating a schematic configuration of a server and an unmanned aircraft of FIG. 1;

FIG. 3 illustrates an example of route guidance for an unmanned aircraft;

FIG. 4 illustrates a route selection for an unmanned aircraft at a junction;

FIG. 5 is a flowchart illustrating processing executed by a first controller and a second controller;

FIG. 6 is a block diagram illustrating another schematic example configuration of the server and the unmanned aircraft; and

FIG. 7 is a block diagram illustrating still another schematic example configuration of the server and the unmanned aircraft.

### DETAILED DESCRIPTION

An embodiment of the present disclosure will be described below with reference to the drawings. The drawings used in the following description are schematic. Dimensional ratios or the like on the drawings do not necessarily match actual ones.

(Unmanned Aircraft Control System)

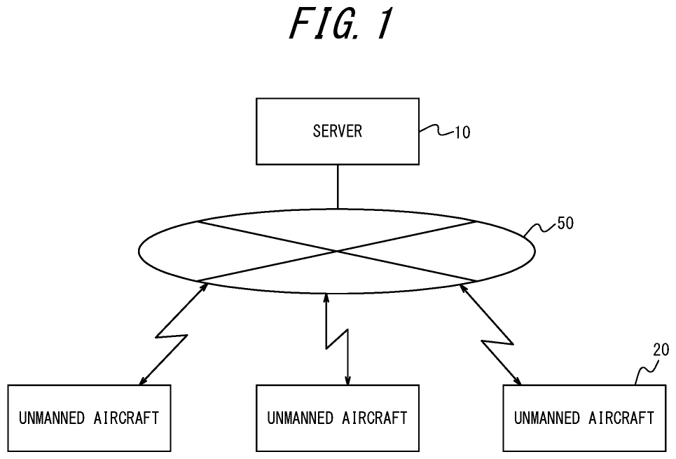

FIG. 1 illustrates a schematic configuration of an unmanned aircraft control system for controlling a route of an unmanned aircraft 20 according to an embodiment. The unmanned aircraft control system includes a server 10 and one or more unmanned aircraft 20. The server 10 is an information processing apparatus that is capable of setting a destination for each unmanned aircraft 20. The server 10 may generate, for each unmanned aircraft 20, a flight route to be transmitted. The server 10 may acquire, from each unmanned aircraft 20, the current position and manage the current position of the unmanned aircraft 20. The number of servers 10 is not limited to one, and servers 10 may be arranged in a plurality of different locations in a distributed manner.

Each unmanned aircraft 20 is a flying object that flies at least partially autonomously in response to instructions from the server 10 regarding its destination. Each unmanned aircraft 20 is also referred to as a drone. In the present embodiment, each unmanned aircraft 20 is used for logistics. Each unmanned aircraft 20 loads luggage at a departure point and delivers the luggage to a destination. The unmanned aircraft 20 includes a plurality of rotary wings, which can be rotated to generate lift. It is assumed that each unmanned aircraft 20 in the present embodiment has a body capable of carrying small luggage ranging from around several hundred grams to several kilograms. Each unmanned aircraft 20 according to the present disclosure, however, may be configured to be able to deliver larger luggage.

The server 10 and each unmanned aircraft 20 are connected via a network 50 for communication. The server 10 and the network 50 are connected by a wired or wireless communication system. The network 50 includes a wide area network such as the Internet, a Virtual Private Network (VPN), and a network using a dedicated line. Each unmanned aircraft 20 and the network 50 are connected by a wireless communication system. Methods for connecting each unmanned aircraft 20 to the network 50 may include, but are not limited to, methods using the 3rd Generation (3G) mobile communication system, the 4th Generation (4G) mobile communication system such as Long Term Evolution (LTE), the 5th Generation (5G) mobile communication system, Wi-Fi® (Wi-Fi is a registered trademark in Japan, other countries, or both), and Worldwide Interoperability for Microwave Access (WiMAX).

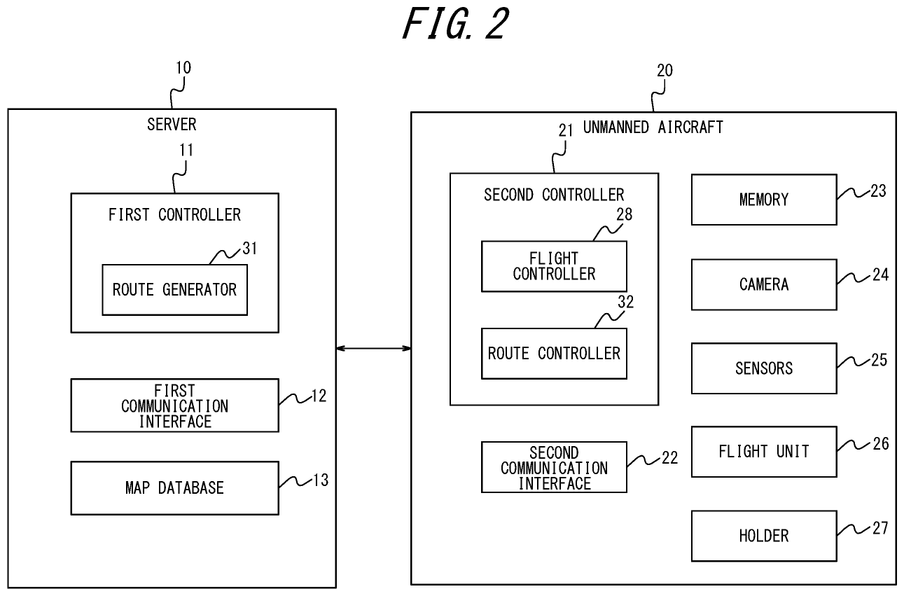

More detailed configurations of the server 10 and an unmanned aircraft 20 are illustrated in FIG. 2.

(Server)

The server 10 includes a first controller 11, a first communication interface 12, and a map database 13.

The first controller 11 is configured with a single processor or a plurality of processors. Processors include general purpose processors that execute programmed functions by loading a specific program, and dedicated processors that are dedicated to specific processing. Dedicated processors may include Digital Signal Processors (DSPs), Application Specific Integrated Circuits (ASICs), Field-Programmable Gate Arrays (FPGAs), and the like. A processor constituting the first controller 11 is a first processor. The first controller 11 may include a program executed by a processor and a memory that can store information or the like being processed by a processor.

The first communication interface 12 includes a communication interface for wired or wireless connection to the network 50. The first communication interface 12 performs processing, such as protocol processing pertaining to information transmission and receipt, modulation of transmitted signals, or demodulation of received signals. The first communication interface 12 can transmit and receive information to and from an unmanned aircraft 20 via the network 50.

The map database 13 is a database that stores map information for the entire area in which each unmanned aircraft 20 can fly. The map database 13 contains information on roads and waterways. The map database 13 contains three-dimensional information on unevenness of terrain, three-dimensional structures on roads such as buildings, telephone poles, or pedestrian bridges, three-dimensional intersections of roads, or the like. The map database 13 may further contain information on areas in which flight is not possible. For example, flight of an unmanned aircraft is prohibited by law in the vicinity of a specific facility.

In the present application, the term “waterway” is used in a broad sense to mean a continuous area with a water surface. A waterway includes a water surface on which a watercraft or the like can travel and a passage through which water can flow. For example, a waterway includes a river, a canal, a channel, or the like.

The first controller 11 controls the components of the server 10. The first controller 11 transmits and receives information to and from each unmanned aircraft 20 via the first communication interface 12. The first controller 11 can receive an external input and set a destination and a route to the destination for an unmanned aircraft 20.

The first controller 11 includes a route generator 31 that generates a route to be set for an unmanned aircraft 20. The route generator 31 may be implemented as a hardware module or a software module. The route generator 31 generates a route for flying to a destination preferentially over a road and a waterway, based on the current position of the unmanned aircraft 20, the destination, and the map information in the map database 13. The first controller 11 transmits information on the generated route to the unmanned aircraft 20 via the first communication interface 12.

Because an unmanned aircraft 20 flies preferentially over a road or a waterway, selecting a safe flight route is easier. Even if a fault occurs during flight, the unmanned aircraft 20 can land safely on a road or a waterway. Further, the unmanned aircraft 20 selects a route that has the fewest possible number of pedestrians and vehicles passing through, so as to safely fly to a destination. This reduces the risk of the unmanned aircraft 20 colliding with a pedestrian or a vehicle even in the event of a fault. In particular, the unmanned aircraft 20 is able to fly without causing a sense of fear and restriction among pedestrians that the unmanned aircraft 20 may fall on them.

In a case in which there are a plurality of routes from a departure point to a destination when generating a route for an unmanned aircraft 20 to fly, the route generator 31 evaluates the level of risk for each route. The route generator 31 selects a route to be flown from a plurality of candidate routes so as to minimize risk based on the evaluated level of risk.

For example, it is desirable that as few pedestrians and vehicles as possible pass through a route for an unmanned aircraft 20 to fly. In a case in which there is no pedestrian or vehicle passing through, there is no risk of colliding with a pedestrian or a vehicle even if a fault of the unmanned aircraft 20 occurs. For this reason, the route generator 31 acquires information on traffic volume for each candidate route. The information on traffic volume may be acquired from an external source via the first communication interface 12. Alternatively, the route generator 31 may acquire information on traffic volume for each road at each time frame in the past that is stored in the server 10.

When generating a route for an unmanned aircraft 20, the route generator 31 calculates the length of distance of each candidate route. The route generator 31 can evaluate that risk is higher in a case in which the length of distance is longer than in a case in which the length of distance is shorter.

The map database 13 may also contain the presence or absence of a stopping lane and a median strip, as information on a road. The stopping lane is a strip-shaped part of a roadway that is provided for a vehicle to stop. The median strip is an area provided in the middle of a roadway so as to separate opposing travel directions of the roadway. Based on the map database 13, the route generator 31 evaluates that risk is lower in a case in which there is a stopping lane or a median strip on a road included in a candidate route than in a case in which there is no stopping lane or median strip. When there is a stopping lane or a median strip on a road, an unmanned aircraft 20 can fly over the stopping lane or the median strip. In a case in which an unmanned aircraft 20 flies over a stopping lane or a median strip, even in the event of a fault of the unmanned aircraft 20, it is unlikely that the unmanned aircraft 20 will collide with a pedestrian or a vehicle because it can land on the stopping lane or the median strip that does not have a pedestrian or a vehicle passing through.

Further, the map database 13 may contain information on whether a pedestrian travel lane and a vehicle travel lane are separated, as information on a road. When a sidewalk and a roadway are provided on a road, a pedestrian travel lane and a vehicle travel lane are separated. The route generator 31 can evaluate that risk is lower in a case in which a pedestrian travel lane and a vehicle travel lane are separated on a road included in a candidate route than in a case in which a pedestrian travel lane and a vehicle travel lane are not separated. When a pedestrian travel lane and a vehicle travel lane are separated, an unmanned aircraft 20 can fly over the vehicle travel lane. In a case in which an unmanned aircraft 20 flies over a vehicle travel lane, it is unlikely that the unmanned aircraft 20 will collide with a pedestrian even in the event of a fault of the unmanned aircraft 20.

The route generator 31 can generate a route so that an unmanned aircraft 20 will fly over a road, an expressway, and a railroad track on which the speed limit is greater than or equal to a predetermined speed as infrequently as possible. The predetermined speed is determined by evaluating the level of risk in the unlikely event that the unmanned aircraft 20 and a vehicle collide with each other. The predetermined speed is, for example, 60 km/h. Such a road and a railroad track can be excluded from a route for the unmanned aircraft 20 because it is unlikely that the unmanned aircraft 20 can safely land there in the event of a fault of the unmanned aircraft 20. The unmanned aircraft 20 can cross such a road or a railroad track. The unmanned aircraft 20, however, can be routed to fly over the road or the railroad track without flying along the road or the railway track.

The route generator 31 can generate a route so that an unmanned aircraft 20 will not fly over a section of a road that is for pedestrians only. The section of the road that is for pedestrians only includes, for example, a pedestrian zone (e.g., a so-called “vehicle-free zone”) that operates on holidays or the like so as to be closed for vehicles. Since it is often the case that many pedestrians are in the pedestrian zone, an unmanned aircraft 20 flying in the airspace may cause a sense of fear and restriction among the pedestrians.

The route generator 31 may generate a flight route for an unmanned aircraft 20 so that the unmanned aircraft 20 will not fly along a route including a road with a structure. The structure on the road includes a pedestrian bridge, an information sign on the road, or the like.

The route generator 31 may generate a route from the current position of an unmanned aircraft 20 to a destination in accordance with the map information stored in the map database 13 in a manner similar to a navigation system. In a case in which the unmanned aircraft 20 has not departed yet, the current position is used as the departure point. Unlike a navigation system, the route generator 31 does not need to comply with traffic regulations, such as one-way traffic or right-turn prohibition. It is possible that, when generating a route, the route generator 31 is not able to set a route on a road in a case in which there is a three-dimensional intersection of roads, a tunnel, or the like.

(Unmanned Aircraft)

In an embodiment, each unmanned aircraft 20 includes a second controller 21, a second communication interface 22, a memory 23, a camera 24, sensors 25, a flight unit 26, and a holder 27.

The second controller 21 is configured with a single processor or a plurality of processors, as is the case with the first controller 11. A processor constituting the second controller 21 is a second processor. The second controller 21 controls components of and the entire unmanned aircraft 20. Processing executed by the second controller 21 will be further described later.

The second communication interface 22 includes a communication interface for wireless connection to the network 50. The second communication interface 22 performs processing, such as protocol processing pertaining to information transmission and receipt, modulation of transmitted signals, or demodulation of received signals. The second communication interface 22 can transmit and receive information to and from the server 10 via the network 50.

The memory 23 includes a semiconductor storage device. The semiconductor storage device may include Read Only Memory (ROM), Random Access Memory (RAM), flash memory, and the like. RAM may include Dynamic Random Access Memory (DRAM) and Static Random Access Memory (SRAM). The memory 23 can store a program executed by the second controller 21, information being operated by the second controller 21, or the like. The memory 23 further stores route information from a departure point to a destination that is received from the server 10. The memory 23 may store map information on the vicinity of a route that the unmanned aircraft 20 is scheduled to fly. The unmanned aircraft 20 may acquire, from the server 10, part of the map information contained in the map database 13 of the server 10.

The camera 24 includes an optical system, such as a lens, and an image sensor, such as a Charge-Coupled Device (CCD) image sensor or a Complementary MOS (CMOS) image sensor. The camera 24 captures an image of the vicinity of the unmanned aircraft 20. The camera 24 may continuously capture an image at a predetermined frame rate, e.g., 30 frame per second (fps). The camera 24 transmits a signal corresponding to the captured image to the second controller 21.

The sensors 25 includes a number of sensors. The sensors 25 may include a positioning sensor, a direction sensor, an acceleration sensor, an angular velocity sensor, a height-above-ground sensor, an obstacle sensor, and the like. The positioning sensor can detect an absolute position in latitude and longitude or the like. The positioning sensor may include a receiving apparatus compliant with Global Navigation Satellite System (GNSS). The receiving apparatus compliant with GNSS includes a Global Positioning System (GPS) receiver. The direction sensor can measure a direction by detecting magnetic force of the terrestrial magnetism. As the acceleration sensor and the angular velocity sensor, a gyro sensor may be used. As the height-above-ground sensor and the obstacle sensor, an ultrasonic sensor, an infrared sensor, or the like is used. The sensors 25 may further include an atmosphere pressure sensor or the like.

The flight unit 26 includes a plurality of rotary wings and their drive apparatus. The number of rotary wings may be, for example, four or six, but is not limited thereto. For example, a plurality of rotary wings is radially arranged about the center of the body of the unmanned aircraft 20. The flight unit 26 can cause the unmanned aircraft 20 to perform various operations, such as remaining stationary, ascending, descending, advancing, retracting, or turning, by adjusting the respective rotational speeds of the rotary wings under the control of the second controller 21.

The holder 27 holds luggage. The holder 27 may include an arm for holding luggage. The holder 27 can hold luggage during flight and release the luggage at a destination by spreading the arm, under the control of the second controller 21.

Based on the destination set by the server 10 and route information, the second controller 21 causes the unmanned aircraft 20 to fly to the destination while controlling the components of the unmanned aircraft 20. The second controller 21 may include two functional blocks, that is, a flight controller 28 and a route controller 32. The flight controller 28 and the route controller 32 may be implemented as hardware modules or software modules.

By controlling the components of the flight unit 26 in accordance with detection results of the sensors 25, the flight controller 28 autonomously maintains a flight state. For example, the flight controller 28 maintains a predetermined distance from the ground. The predetermined distance may be set to, for example, 3 m, 6 m, 9 m, or the like. In a case in which the position of the unmanned aircraft 20 deviates from the route due to an external factor, such as wind, the flight controller 28 controls the flight unit 26 so as to return to the route. Further, in a case in which an unexpected obstacle, such as a bird, is detected ahead by the sensors 25, the flight controller 28 may control the flight unit 26 to bypass the obstacle.

In a case in which there is a pedestrian or a vehicle on a road included in the route that is being flown, the flight controller 28 may control the flight unit 26 to avoid flying over the pedestrian or the vehicle. This prevents the unmanned aircraft 20 from flying directly above the pedestrian or the vehicle, thereby not causing a sense of fear and restriction to the pedestrian or a driver. Further, the risk of the unmanned aircraft 20 colliding with the pedestrian or the vehicle can be reduced even if a fault of the unmanned aircraft 20 occurs.

The flight controller 28 in flight may also continuously transmit positioning information acquired by the sensors 25 to the server 10 via the second communication interface 22. This allows the first controller 11 of the server 10 to manage the current position of the unmanned aircraft 20. Further, in a case in which a failure of the unmanned aircraft 20 occurs and transmission of positioning information is terminated, the first controller 11 of the server 10 can recognize occurrence of the fault and identify a position at which the fault has occurred.

In a case in which occurrence of a defect in the flight function of the unmanned aircraft 20 is detected, the flight controller 28 may transmit emergency information to the server 10 or to another apparatus. The emergency information may include current positional information for the unmanned aircraft 20. An organization operating the unmanned aircraft 20 may dispatch a person in charge of collection of the unmanned aircraft 20 and the luggage based on the emergency information received via the server 10 or the other apparatus.

The route controller 32 controls a route for the unmanned aircraft 20 to fly, based on the destination and the route information that are received from the server 10 and stored in the memory 23. The route controller 32 may dynamically generate a route from the current position to the destination again, in accordance with traffic volume or the like on a road that is to be used for flight. The route that the route controller 32 generates again is also selected so that the flight will be performed preferentially over a road and a waterway.

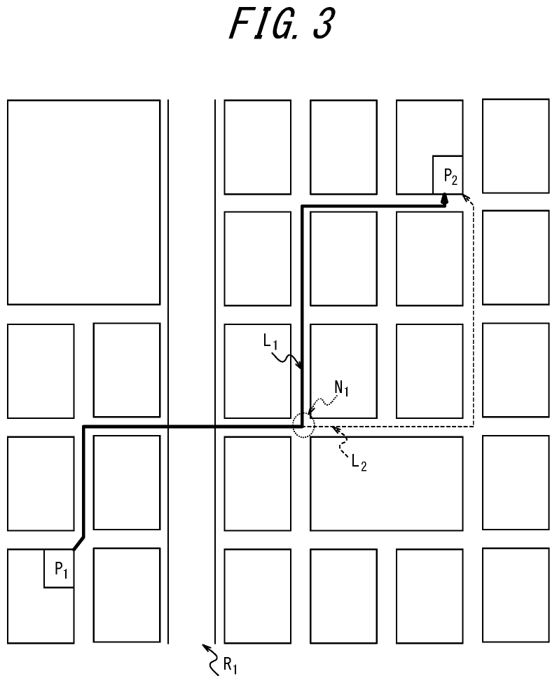

With reference to FIG. 3, route control by the route controller 32 for an unmanned aircraft 20 in flight will be described. In the figure, R1 indicates a highway on which the speed limit is 60 km/h. Other roads are regular roads on which the speed limits are approximately 40 km/h. The unmanned aircraft 20 delivers luggage from a departure point P1 to a destination P2.

Firstly, the route generator 31 of the first controller 11 of the server 10 generates a route from the departure point P1 to the destination P2 of the unmanned aircraft 20, as illustrated by the solid line of FIG. 3. The unmanned aircraft 20 receives, from the server 10, positional information for the destination P2 and route information to the destination P2, and map information for the vicinity thereof.

After departing from the departure point P1, the unmanned aircraft 20 flies along the route indicated by the solid line in accordance with the route information generated by the server 10. The route generated by the server 10 includes a plurality of junctions. The junctions correspond to intersections of roads, for example. At each point in time, the route for the unmanned aircraft 20 includes a link that sequentially connects the current position, junctions, and the destination P2. The link indicates, for example, a section of a road that is located between two intersections, and a section on a waterway sandwiched by roads that is located between two points between which the unmanned aircraft 20 can travel.

Each time the unmanned aircraft 20 reaches one of the junctions, the route controller 32 can evaluate the route that is currently being flown and change the route as needed. For this purpose, the route controller 32 may acquire traffic volume information indicating traffic volume of pedestrians or vehicles passing through a subsequent link each time the unmanned aircraft 20 reaches one of the junctions. The route controller 32 can acquire traffic volume information from an image captured by the camera 24. Thus, the route controller 32 can perform image recognition on an image captured by the camera 24 and extract images of pedestrians and vehicles. The route controller 32 may acquire traffic volume information from traffic information provided from outside of the unmanned aircraft 20.

In the example illustrated in FIG. 3, after departing the departure point P1, the unmanned aircraft 20 follows the route generated by the route generator 31 and reaches the junction N1. At the junction N1, the route controller 32 may determine that traffic volume on the link L1 of the route that is being flown is greater than predetermined traffic volume. In that case, at the junction N1, the route controller 32 compares traffic volume on the link L1 and traffic volume on the link L2 from captured images of the link L1 and the link L2. For example, when it is determined that the traffic volume on the link L2 is smaller than the traffic volume on the link L1, the route controller 32 may newly generate a route again from the current position to the destination P2 that follows the link L2 indicated by a dashed line. After passing through the junction N1, the unmanned aircraft 20 may fly along the route that has been generated again as indicated by the dashed line.

At the junction N1, based on traffic volume information for the subsequent link L1 and the other link L2 that the unmanned aircraft 20 can turn onto and on a distance to be flown from the current position to the destination P2 over each of the links L1, L2, the route controller 32 may evaluate risk when each of the links L1, L2 is followed. Based on the evaluated risk, the route controller 32 may generate a route again so as to follow one of the links L1, L2 with lower risk. Risk can be quantified for comparison.

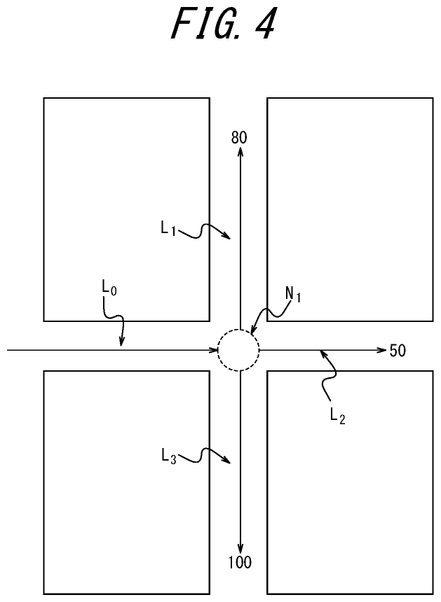

FIG. 4 illustrates an example of route selection. Upon reaching the junction N1 after passing through the link L0 before the junction N1, the unmanned aircraft 20 captures images of the links L1, L2, and L3 that diverge from the junction N1 using the camera 24, to thereby detect traffic volume on each link. Because the link L3 is located in a direction away from the destination P2, the route controller 32 evaluates that this is a route that cannot be used and that has a level of risk of 100. The route controller 32 may quantify traffic volume and a remaining flight distance for each route separately and calculate the level of risk using a product of the traffic volume and the remaining flight distance. In the example of FIG. 3, the link L1 has a level of risk of 80, and the link L2 has a level of risk of 50. The route controller 32 may use a route that follows the link L2 with the lower level of risk. The route controller 32 resets the route to the destination P2 to the route that follows the link L2.

At each junction, the unmanned aircraft 20 may sequentially select a route that includes a subsequent link with low traffic volume of pedestrians and vehicles. This allows the unmanned aircraft 20 to fly by selecting a route that has the fewest possible number of pedestrians and vehicles passing through. Additionally, although in the above description the unmanned aircraft 20 detects traffic volume on a road, when flying a route over a waterway, the unmanned aircraft 20 can similarly perform detection and evaluation with respect to a vessel or the like passing through the waterway.

Generating a route by the route generator 31 and generating a route by the route controller 32 again may take into account various conditions other than the conditions described above.

The route generator 31 and the route controller 32 may generate a route by considering the type or weight of the aforementioned luggage. For example, in a case in which the luggage is heavy, if the unmanned aircraft 20 falls due to a fault and when it collides with a pedestrian or a vehicle, it may cause significant damage. For this reason, in a case in which the weight of the luggage is greater than a predetermined weight, the unmanned aircraft 20 may be controlled to fly by selecting a route that rarely has pedestrians and vehicles passing through.

Further, the route generator 31 and the route controller 32 may generate a route by considering a weather condition. For example, in a case in which the weather is windy, the unmanned aircraft 20, when near tall buildings, is affected by wind blowing through tall buildings. For this reason, in a case in which wind the intensity of wind is greater than a predetermined intensity, the unmanned aircraft 20 may be controlled to fly by selecting a route over a road or a waterway that has no tall buildings in the vicinity.

(Flow of Control Method for Unmanned Aircraft)

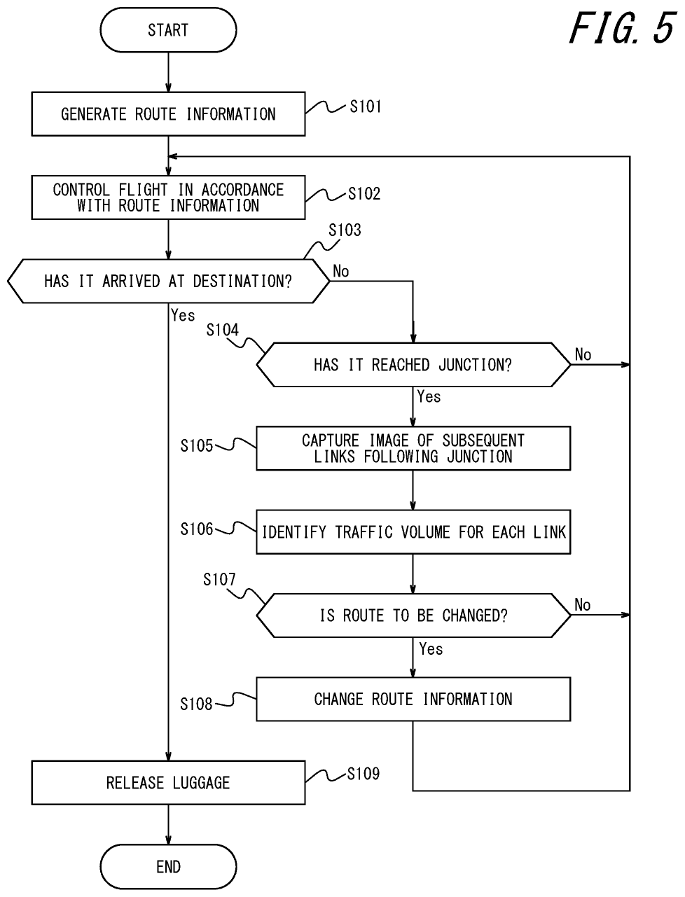

Hereinafter, a control method for an unmanned aircraft 20 will be described with reference to FIG. 5.

Firstly, the first controller 11 of the server 10 generates a route for an unmanned aircraft 20 to fly from a departure point (current position) to a destination preferentially over a road and a waterway (Step S101).

The second controller 21 of the unmanned aircraft 20 controls flight of the unmanned aircraft 20 in accordance with route information generated by the server 10 (Step 102). The second controller 21 determines whether the unmanned aircraft 20 has arrived at the destination (Step S103).

Upon determining that it has not arrived at the destination (Step S103: No), the second controller 21 determines whether it has reached a junction (Step S104).

When it has not arrived at the destination (Step S103: No) and when it has not reached a junction (Step S104: No), the second controller 21 repeats Step S102 through S104 until it arrives at the destination or reaches a junction.

When it has reached a junction (Step S104: Yes), the second controller 21 controls the camera 24 to capture images of subsequent links following the junction (Step S105). For this purpose, the second controller 21 may remain stationary at the junction and change the direction of the unmanned aircraft 20 so as to direct the camera 24 toward the links to capture images. The camera 24 may include a wide-angle lens that can be directed to capture an image of a plurality of links at once.

The second controller 21 acquires the images of the links from the camera 24 and identifies traffic volume of pedestrians and vehicles for each link (Step S106).

The second controller 21 compares a link included in the currently set route with another link so as to determine whether to change the route for the unmanned aircraft 20 to fly (Step S107). For example, in a case in which the second controller 21 determines that traffic volume of pedestrians and/or vehicles on the link included in the current route is smaller than a predetermined value, the current route can be followed as it is. In a case in which the second controller 21 determines that traffic volume of pedestrians and/or vehicles on the link included in the current route is greater than the predetermined value and that traffic volume on another link is smaller than the predetermined value, the second controller 21 determines whether to change the route. In determination of whether to change the route, a flight distance to the destination is considered. The predetermined value is set in consideration of safety when the unmanned aircraft 20 flies a link.

In a case in which it is determined that the route is not to be changed in Step S107 (Step S107: No), the second controller 21 follows the set route, while returning to Step S102 and repeat processing of Step S102 and onward.

In a case in which it is determined that the route is to be changed in Step S107 (Step S107: Yes), the second controller 21 changes the route information to that for a new route (Step S108). The second controller 21 sets the new route so that the unmanned aircraft 20 will fly preferentially over a road or a waterway. The second controller 21 follows the new route, while returning to Step S102 and repeat processing of Step S102 and onward.

Upon arriving at the destination after passing through each junction by controlling the unmanned aircraft 20 (Step S103: Yes), the second controller 21 allows the luggage to be released at the destination (Step S109). The unmanned aircraft 20 may land at the destination and release the luggage before taking off again. Alternatively, the unmanned aircraft 20 may drop the luggage while flying over the destination.

The unmanned aircraft 20 may be programmed in advance to return to the departure point upon completion of delivery of the luggage. Alternatively, upon completion of delivery of the luggage, the unmanned aircraft 20 may fly to another point in response to an instruction from the server 10.

As described above, according to the present embodiment, an unmanned aircraft 20 is caused to fly along a safe route to a destination. Because an unmanned aircraft 20 flies along a route that has the fewest possible number of pedestrians and vehicles passing through, the risk of causing a sense of fear and restriction to a pedestrian or a driver of a vehicle and of colliding with a pedestrian or a vehicle in the event of a fault can be reduced.

In the above embodiment, the route generator 31 is included in the first controller 11 of the server 10, and the route controller 32 is included in the second controller 21 of an unmanned aircraft 20. The functions of the route generator 31 and the route controller 32, however, can be optionally included so as to be distributed between the server 10 and the unmanned aircraft 20.

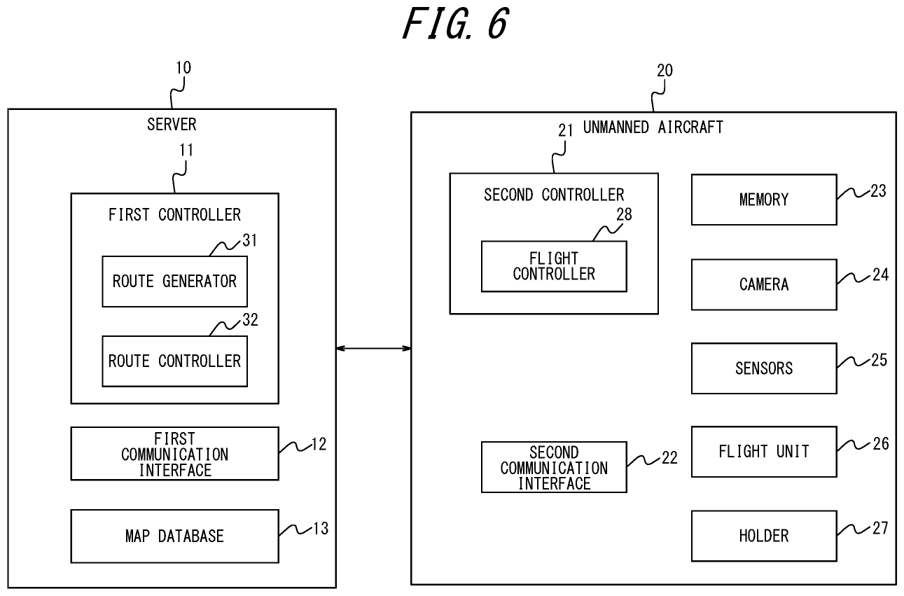

For example, as illustrated in FIG. 6, the functions of the route generator 31 and the route controller 32 can be included in the first controller 11 of the server 10. In this case, at each junction, the second controller 21 of an unmanned aircraft 20 transmits, to the server 10 via the second communication interface 22, an image captured by the camera 24 or information on traffic volume for each link that is obtained from analyzing an image captured by the camera 24. Based on information received from the unmanned aircraft 20 using the first communication interface 12, the server 10 determines whether the route controller 32 of the first controller 11 is to generate a route again for the unmanned aircraft 20 to fly. In a case in which a route has been generated again, the first controller 11 transmits the route that has been generated again to the unmanned aircraft 20 via the first communication interface 12.

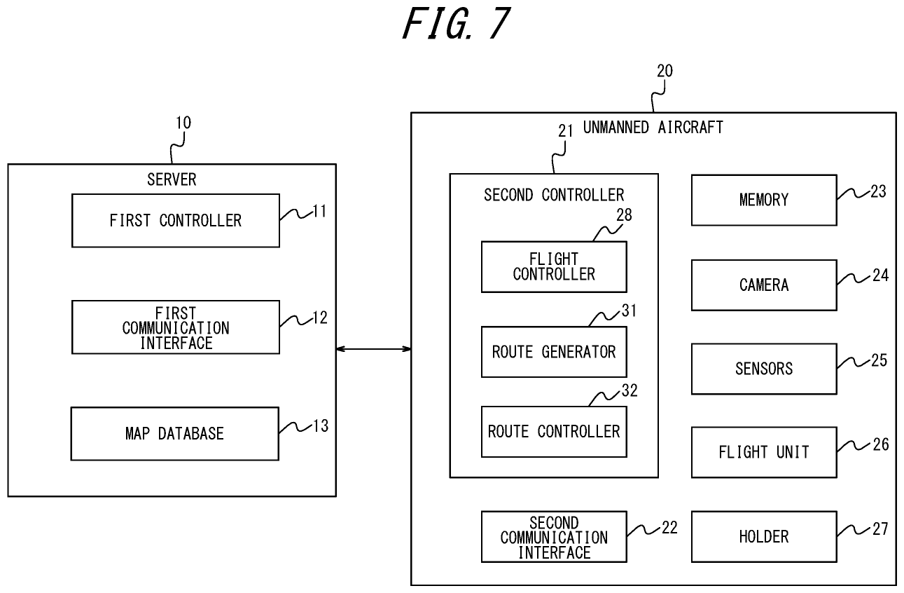

Further, as illustrated in FIG. 7, the functions of the route generator 31 and the route controller 32 can be included in the second controller 21 of an unmanned aircraft 20. In this case, the first controller 11 of the server 10 firstly transmits, to an unmanned aircraft 20 via the first communication interface 12, positional information for a destination and map information on the vicinity including a departure point and the destination. In the unmanned aircraft 20, the route generator 31 of the second controller 21 generates a route to the destination. After leaving the departure point, the route controller 32 of the second controller 21 generates a route from the current position to the destination again as needed.

Additionally, the present disclosure is not limited to the above embodiment, and various modifications and revisions may be implemented. For example, functions or the like included in each means, each step, or the like can be rearranged without logical inconsistency, and a plurality of means, steps, or the like can be combined together or divided.

The control method for an unmanned aircraft 20 disclosed herein can be performed according to a program by processors included in the server 10 and the unmanned aircraft 20. Such a program can be stored in a non-transitory computer readable medium. Examples of non-transitory computer readable media may include, but are not limited to, a hard disk, RAM, ROM, flash memory, a CD-ROM, an optical storage device, and a magnetic storage device.

1. A control method for an unmanned aircraft, comprising
generating, by a processor, a route for flying preferentially over a road and a waterway, based on a current position of the unmanned aircraft, a destination, and map information, and controlling flight of the unmanned aircraft based on the generated route.

2. The control method according to claim 1, comprising
in a case in which there are a plurality of candidate routes from the current position to the destination, the generating of the route includes evaluating, by the processor, a level of risk for each candidate route and selecting a route to be flown from the plurality of candidate routes based on the level of risk.

3. The control method according to claim 2, wherein
the evaluating of the level of risk includes acquiring, by the processor, information on traffic volume pertaining to each candidate route in the plurality of candidate routes and evaluating that the level of risk is higher in a case in which the traffic volume is greater than in a case in which the traffic volume is smaller.

4. The control method according to claim 2, wherein
the evaluating of the level of risk includes calculating, by the processor, a length of distance pertaining to each candidate route in the plurality of candidate routes and evaluating that the level of risk is higher in a case in which the length of distance is longer than in a case in which the length of distance is shorter.

5. The control method according to claim 2, wherein
the evaluating of the level of risk includes evaluating, by the processor, that the level of risk is lower in a case in which there is a stopping lane or a median strip on a road included in a candidate route in the plurality of candidate routes than in a case in which there is no stopping lane or median strip.

6. The control method according to claim 2, wherein
the evaluating of the level of risk includes evaluating, by the processor, that the level of risk is lower in a case in which a pedestrian travel lane and a vehicle travel lane are separated on a road included in a candidate route in the plurality of candidate routes than in a case in which a pedestrian travel lane and a vehicle travel lane are not separated.

7. The control method according to claim 6, wherein
the controlling of the flight includes controlling, by the processor, the unmanned aircraft to fly preferentially over the vehicle travel lane.

8. The control method according to claim 1, wherein
the generating of the route includes generating, by the processor, a route so that flight over a road, an expressway, and a railroad track on which a speed limit is greater than or equal to a predetermined speed and/or over a section of a road that is for pedestrians only is not to be performed.

9. The control method according to claim 1, wherein
the generating of the route includes generating, by the processor, a route so that flight along a route including a road with a structure is not to be performed.

10. The control method according to claim 1, wherein
the generated route includes one or more junctions for turning onto another route, and the route is configured to include a link that sequentially connects the current position, the one or more junctions, and the destination, and
the control method comprises
each time the unmanned aircraft reaches a junction in the one or more junctions, acquiring, by the processor, traffic volume information indicating traffic volume of pedestrians or vehicles passing through a subsequent link.

11. The control method according to claim 10, wherein
the acquiring of the traffic volume information includes acquiring, by the processor, the traffic volume information from an image captured by a camera.

12. The control method according to claim 10, wherein
the acquiring of the traffic volume information includes acquiring, by the processor, the traffic volume information from outside of the unmanned aircraft.

13. The control method according to claim 10, comprising
determining, by the processor, whether to generate a route again based on the traffic volume information.

14. The control method according to claim 13, comprising
at each junction in the one or more junctions, evaluating, by the processor, risk when each link is followed based on traffic information for the subsequent link and for another link that the unmanned aircraft can turn onto and on a distance to be flown to the destination over each link, and generating a route again so as to follow one of the links with lower risk.

15. The control method according to claim 1, wherein
the controlling of the flight includes controlling, by the processor, the unmanned aircraft to avoid flying over pedestrians and vehicles.

16. The control method according to claim 1, wherein
the unmanned aircraft is configured to deliver luggage, and
the generating of the route includes generating, by the processor, the route by considering the type and/or weight of the luggage.

17. The control method according to claim 1, comprising
transmitting, by the processor, emergency information to outside of the unmanned aircraft upon detection of a defect of the unmanned aircraft.

18. The control method according to claim 1 that is implemented by the processor, the processor being arranged so as to be distributed between the unmanned aircraft and a server external to the unmanned aircraft.

19. A server, comprising
a first communication interface configured to transmit and receive information to and from a plurality of unmanned aircraft;
a first processor; and
a map database configured to store map information, wherein
the first processor is configured to generate a route for flying preferentially over a road and a waterway, based on a current position of an unmanned aircraft in the plurality of unmanned aircraft, a destination, and the map information, and transmit route information related to the generated route to the unmanned aircraft via the first communication interface.

20. An unmanned aircraft, comprising:
a second communication interface;
a second processor;
a camera; and
a flight unit, wherein
the second communication interface is configured to receive route information and map information, the route information being related to a route for flying to a destination preferentially over a road and a waterway, and
the second processor is configured to control the flight unit based on the route information and the map information, and generate a route to the destination again based on traffic volume of pedestrians and vehicles passing through the route that is detected from an image captured by the camera during flight.
